(19) United States
(12) Patent Application Publication
(10) Pub. No.: US 2025/0198760 A1
(43) Pub. Date: Jun. 19, 2025

(54) DEVICE AND METHOD FOR VEHICLE POSE ESTIMATION, AND COMPUTER-READABLE STORAGE MEDIUM STORING PROGRAM FOR PERFORMING THE METHOD

(71) Applicant: HL MANDO CORPORATION, Gyeonggi-do (KR)

(72) Inventor: Kyungtack LEE, Gyeonggi-do (KR)

(21) Appl. No.: 18/981,253

(22) Filed: Dec. 13, 2024

(30) Foreign Application Priority Data
Dec. 14, 2023 (KR) 10-2023-0181784

(51) Int. Cl. G01C 21/16; G01P 15/18

(52) U.S. Cl. CPC G01C 21/16; G01P 15/18

(57) ABSTRACT

A device and method for vehicle pose estimation, and a non-transitory computer-readable storage medium storing a program for performing the method estimates a pose of a vehicle. The device includes a first inertial sensor configured to measure acceleration information of the vehicle, a second inertial sensor configured to measure angular velocity information of the vehicle, and a controller configured to input the acceleration information into a first estimation model obtained from the angular velocity information to generate first pose estimation information of the vehicle using output information of the first estimation model, input the acceleration information and the angular velocity information into a second estimation model to generate second pose estimation information of the vehicle using output information of the second estimation model, and generate final pose estimation information of the vehicle using at least one of the first pose estimation information and the second pose estimation information.

### CROSS-REFERENCE TO RELATED APPLICATION

This application claims priority to and the benefit from Korean Patent Application No. 10-2023-0181784, filed on Dec. 14, 2023, the disclosures of which is incorporated herein by reference in its entirety.

### BACKGROUND

### 1. Technical Field

The present disclosure generally relates to a device and method for vehicle pose estimation, and a non-transitory computer-readable storage medium storing a program for performing the method, and more specifically, to a device and method for vehicle pose estimation in which a pose of a vehicle is estimated by utilizing measurement information obtained from the plurality of inertial sensors installed in the vehicle, and a non-transitory computer-readable storage medium storing a program for performing the method.

### 2. Discussion of Related Art

In order to control the pose of a vehicle, accurate values of the vehicle's state angles, such as, yaw, roll, and pitch may be needed. Acceleration sensors, gyro sensors, and the like that are installed in a vehicle to calculate the yaw, roll, and pitch of the vehicle may be used.

An acceleration sensor measures the physical quantity of acceleration. For example, the acceleration sensor may measure gravitational acceleration on an X-axis, a Y-axis, and a Z-axis within a three-dimensional (3D) space. When an angle related to a pose of a vehicle is estimated using a measurement value of the acceleration sensor, errors do not accumulate because an integration process for calculating the acceleration is not required. However, the acceleration sensor may have difficulty in accurately tracking changes due to errors in measurement values.

A gyro sensor measures an angular velocity. Accurate tracking of changes in the pose of the vehicle may be performed by using the gyro sensor. However, to estimate an angle related to the pose of the vehicle using a measurement value of the gyro sensor, an integration process is needed. Therefore, errors in estimating the angle of the pose of the vehicle may accumulate over time and a drift phenomenon may occur in the estimation.

Accordingly, there is a need for improvement in which the advantages of both an acceleration sensor and a gyro sensor may increase or be maximized and the disadvantages may decrease or be compensated for to accurately estimate an angle related to the pose of the vehicle.

Meanwhile, with the development of autonomous driving technology, the level of requirements for securing redundancy related to vehicle safety, robustness of measurements, and the like is increasing. In this regard, a need for developing technology in which an angle related to the pose of the vehicle can be estimated even when any one of an acceleration sensor and a gyro sensor which are installed in a vehicle is not properly working or is in an abnormal or faulty state is increasing.
(Patent Document) Korean Patent No. 1549165, “Vehicle Pose Estimation Device and Vehicle Pose Estimation Method,” issued on Aug. 26, 2015.

### SUMMARY

Some exemplary embodiments of the present disclosure may provide a device and method for vehicle pose estimation in which an angle related to a pose of a vehicle may be accurately estimated by utilizing different types of inertial sensors in combination, and a non-transitory computer-readable storage medium storing a program for performing the method.

Certain exemplary embodiments of the present disclosure may provide a device and method for vehicle pose estimation in which an angle related to a pose of a vehicle can be accurately estimated even when any one of a plurality of inertial sensors is not properly working or is in an abnormal or faulty state, and a non-transitory computer-readable storage medium storing a program for performing the method.

The objects of the present disclosure are not limited to the above-described objects, and other objects that are not mentioned will be able to be clearly understood by those skilled in the art to which the present disclosure pertains from the following description.

According to an aspect of the present disclosure, there is provided a vehicle pose estimation device, which is a device for estimating a pose of a vehicle, including a first inertial sensor configured to measure acceleration of the vehicle, a second inertial sensor configured to measure an angular velocity of the vehicle, a first estimator configured to generate first pose estimation information about the vehicle using the acceleration and an estimated model variable obtained from the angular velocity, a second estimator configured to receive the acceleration and the angular velocity and generate second pose estimation information about the vehicle, and a controller configured to generate final pose estimation information about the vehicle using at least one of the first pose estimation information and the second pose estimation information.

The first pose estimation information, the second pose estimation information, and the final pose estimation information may include an Euler angle of the vehicle.

The first inertial sensor may measure 3-axis accelerations, and the second inertial sensor may measure 3-axis angular velocities.

The first estimator may generate the first pose estimation information using a Kalman filter.

The 3-axis accelerations may be converted into a quaternion and input into the first estimator.

The second estimator may generate the second pose estimation information using a sliding mode observer.

When the controller receives a failure signal for the first inertial sensor from the outside and does not receive a failure signal for the second inertial sensor, the controller may generate the final pose estimation information to be the same as the second pose estimation information.

When the controller receives a failure signal for the second inertial sensor from the outside and does not receive a failure signal for the first inertial sensor, the controller may generate the final pose estimation information to be the same as the first pose estimation information.

The controller may determine a failure situation when the first pose estimation information and the second pose estimation information differ by a predetermined standard or more.

When the failure situation is determined, the controller may generate the final pose estimation information by mixing the first pose estimation information and the second pose estimation information.

When the failure situation is determined, the controller may generate an average value of the first pose estimation information and the second pose estimation information as the final pose estimation information.

According to another aspect of the present disclosure, there is provided a vehicle pose estimation method, which is a method of estimating a pose of a vehicle, including generating, by a first estimator, first pose estimation information about the vehicle using acceleration measured by a first inertial sensor and an estimated model variable obtained from an angular velocity measured by a second inertial sensor, receiving, by a second estimator, the acceleration and the angular velocity and generating second pose estimation information about the vehicle, and generating, by a controller, final pose estimation information about the vehicle using at least one of the first pose estimation information and the second pose estimation information.

The first pose estimation information, the second pose estimation information, and the final pose estimation information may include an Euler angle of the vehicle.

The acceleration may include 3-axis accelerations, and the angular velocity may include 3-axis angular velocities.

The first estimator may generate the first pose estimation information using a Kalman filter.

The 3-axis accelerations may be converted into a quaternion and input into the first estimator.

The second estimator may generate the second pose estimation information using a sliding mode observer.

In the generating of the final pose estimation information, when the controller receives a failure signal for the first inertial sensor from the outside and does not receive a failure signal for the second inertial sensor, the controller may generate the final pose estimation information to be the same as the second pose estimation information.

In the generating of the final pose estimation information, when the controller receives a failure signal for the second inertial sensor and does not receive a failure signal for the first inertial sensor, the controller may generate the final pose estimation information to be the same as the first pose estimation information.

In the generating of the final pose estimation information, when the first pose estimation information and the second pose estimation information differ by a predetermined standard or more, the controller may generate the final pose estimation information by mixing the first pose estimation information and the second pose estimation information.

When the controller mixes the first pose estimation information and the second pose estimation information, the controller may generate an average value of the first pose estimation information and the second pose estimation information as the final pose estimation information.

According to still another aspect of the present disclosure, there is provided a non-transitory computer-readable storage medium in which a program including at least one instruction for performing the vehicle pose estimation method is stored.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a configuration of a vehicle pose estimation device according to an embodiment of the present disclosure;

FIG. 2 is a graph showing first pose estimation information and second pose estimation information, which are obtained as results of performing a simulation for a situation in which a first inertial sensor is in an abnormal state and a second inertial sensor is operating normally, and actual vehicle pose information according to an embodiment of the present disclosure;

FIG. 3 is a graph showing first pose estimation information and second pose estimation information, which are obtained as results of performing a simulation for a situation in which a first inertial sensor is operating normally and a second inertial sensor is in an abnormal state, and actual vehicle pose information according to an embodiment of the present disclosure; and

FIG. 4 is a flowchart of a vehicle pose estimation method according to an embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

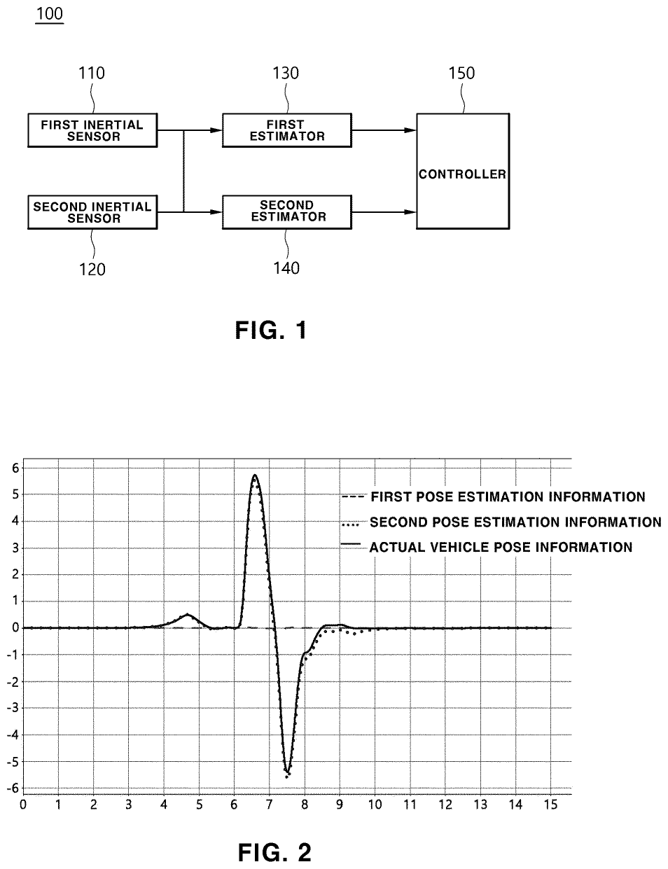

FIG. 1 is a block diagram illustrating a configuration of a vehicle pose estimation device according to an embodiment of the present disclosure.

A vehicle pose estimation device 100 according to the embodiment of the present disclosure estimates a pose of a vehicle. The vehicle pose estimation device 100 according to the embodiment of the present disclosure may generate a plurality of pieces of pose estimation information using different types of inertial sensors in combination, and generate final pose estimation information that may accurately estimate an actual pose of the vehicle by utilizing the plurality of pieces of pose estimation information.

The pose of the vehicle may include, for example, but not limited to, information about at least one of roll, pitch, and yaw of the vehicle. In other words, the pose estimation information of the vehicle may include at least one of a roll angle, a pitch angle, and a yaw angle of the vehicle. Further, the pose estimation information of the vehicle may include an Euler angle that indicates a direction in which the vehicle is placed in a three-dimensional (3D) space. However, the pose estimation information can be any information representing the estimated pose (e.g. a position or orientation) of a vehicle, for instance, but not limited to, an angle of the vehicle.

Referring to FIG. 1, the vehicle pose estimation device 100 according to the embodiment of the present disclosure is a device for estimating a pose of a vehicle. The vehicle pose estimation device may include a first inertial sensor 110, a second inertial sensor 120, a first estimator 130, a second estimator 140, and a controller 150.

The first inertial sensor 110 measures acceleration of the vehicle. For example, the first inertial sensor 110 may measure 3-axis accelerations such as an x-axis acceleration, a y-axis acceleration, and a z-axis acceleration. The first inertial sensor 110 may be included or installed in the vehicle. In an exemplary embodiment, the first inertial sensor 110 may be an acceleration sensor installed in the vehicle, although not required.

The second inertial sensor 120 measures an angular velocity of the vehicle. For instance, the second inertial sensor 120 may measure 3-axis angular velocities such as an x-axis velocity, a y-axis velocity, and a z-axis velocity. The second inertial sensor 120 may be included or installed in the vehicle. In an exemplary embodiment, the second inertial sensor 120 may be a gyro sensor installed in the vehicle, although not required.

The first estimator 130 generates first pose estimation information about the vehicle using the acceleration and an estimated model variable obtained from the angular velocity. The first pose estimation information may include, for example, but not limited to, at least one of the roll angle, the pitch angle, and the yaw angle of the vehicle. Further, the first pose estimation information may include an Euler angle of the vehicle.

In an embodiment of the present disclosure, the first estimator 130 may generate the first pose estimation information using a Kalman filter. The Kalman filter may be a recursive filter configured to estimate a state of a linear dynamical system on the basis of measurements with noise.

The Kalman filter may perform a prediction operation of predicting a measurement value expected when a user input is input in a state in which the state of the linear dynamical system was previously estimated, and a correction operation of comparing the predicted measurement value with an actual measurement value and estimating a current state.

Estimated model variables used in an estimation model of the Kalman filter may be obtained from information about the angular velocity. More specifically, when the information about the angular velocity includes 3-axis angular velocities, the 3-axis angular velocities may be converted into a quaternion and used to avoid a singularity problem.

In this way, a state transition matrix A may be obtained as the estimated model variable using the 3-axis angular velocities converted into the quaternion. In this case, the state transition matrix A may be composed of a 4×4 matrix.

More specifically, when the prediction operation of the Kalman filter is performed, the first estimator 130 may predict a state value using Equation 1 below in which the state value can be obtained using the state transition matrix A, and predict error covariance using Equation 2 below.

$$= A \qquad ( Equation 1 )$$

where x denotes the state value.

$${P}_{\overline{k}} = {AP}_{k - 1} {A}^{T} + Q \qquad ( Equation 2 )$$

where P denotes the error covariance and Q denotes a system noise matrix.

The first estimator 130 may set an initial value according to a predetermined standard. In this case, information about the 3-axis accelerations included in information about the acceleration may be converted into a quaternion and input into Equation 1 and Equation 2.

Next, a Kalman gain may be calculated, and the state value and error covariance that were predicted previously may be corrected using the calculated Kalman gain. The calculation of the Kalman gain may be performed using Equation 3 below, the correction of the state value may be performed using Equation 4 below based on a result of the calculation, and the correction of the error covariance may be performed using Equation 5 below.

$${K}_{k} = {P}_{\overline{k}} {{H}^{T} ( {HP}_{\overline{k}} {H}^{T} + R )}^{- 1} \qquad ( Equation 3 )$$

where K denotes Kalman gain, P denotes the error covariance, H denotes the output matrix and R denotes the covariance matrix of measurement noise.

$$= + {K}_{k} ( {z}_{k} - {Hx}_{\overline{k}} ) \qquad ( Equation 4 )$$

where x denotes the state value, Z denotes the measurement value and H denotes the output matrix.

$${P}_{k} = {P}_{\overline{k}} - {K}_{k} {HP}_{\overline{k}} \qquad ( Equation 5 )$$

where P denotes the error covariance, K denotes Kalman gain and H denotes the output matrix.

A final predicted state value output by the first estimator 130 using the Kalman filter in the above manner has a quaternion form. The first estimator 130 generates the first pose estimation information based on the final predicted state value. The first pose estimation information obtained in this way may include the Euler angle of the vehicle.

The second estimator 140 receives the acceleration and the angular velocity of the vehicle and generates second pose estimation information about the vehicle based on the acceleration and the angular velocity of the vehicle. The second pose estimation information may include, for example, but not limited to, at least one of a roll angle, a pitch angle, and a yaw angle of the vehicle. Further, the second pose estimation information may include the Euler angle of the vehicle.

In an embodiment of the present disclosure, the second estimator 140 may generate the second pose estimation information using a sliding mode observer. The sliding mode observer may have one or more dynamic models, and the second estimator 140 may generate the second pose estimation information from a result value that is derived by inputting the acceleration and the angular velocity of the vehicle into the dynamic models.

An observer is a general term for estimating unmeasurable state variables using measurable state variables. The sliding mode observer is an observer based on the sliding mode theory. The sliding mode theory is a nonlinear control theory that is robust to uncertainty and disturbance. In an embodiment of the present disclosure, the sliding mode observer can be implemented through the equations below.

In detail, in order to estimate the roll angle of the vehicle, the second estimator 140 may use a dynamic model, such as Equation 6 below, and Equation 7.

$$[ \begin{matrix}\dot{\hat{ϕ}} \\ \ddot{\hat{ϕ}}\end{matrix} ] = B [ \begin{matrix}\hat{ϕ} \\ \dot{\hat{ϕ}}\end{matrix} ] + {Ca}_{y} + Gv \qquad ( Equation 6 )$$

where B and C denote system variables obtained through physical information of the vehicle, Gv denotes an error variable, \dot{\hat{ϕ}} denotes an estimated value of a lateral angular velocity, \ddot{\hat{ϕ}} denotes an estimated value of lateral acceleration, and a_{y} denotes the lateral acceleration.

$$\dot{\hat{ϕ}} = [ 01 ] [ \begin{matrix}\hat{ϕ} \\ \dot{\hat{ϕ}}\end{matrix} ] \qquad ( Equation 7 )$$

where \dot{\hat{ϕ}} denotes the estimated value of the lateral angular velocity, \hat{ϕ} and denotes an estimated value of the roll angle.

The lateral acceleration measured by the first inertial sensor 110 may be input into the dynamic model such as Equation 6 above, and the lateral angular velocity measured by the second inertial sensor 120 may be provided as feedback to correct the estimated value of the lateral angular velocity of Equation 6. The second estimator 140 may derive the estimated value for the roll angle of the vehicle using the above dynamic model.

Meanwhile, the second estimator 140 may further use each dynamic model for estimating the pitch angle and yaw angle of the vehicle. For instance, the second estimator 140 uses a sliding mode observer and may estimate each of the pitch angle and yaw angle of the vehicle using a dynamic model for estimating the pitch angle and another dynamic model for estimating the yaw angle.

The second estimator 140 may generate the second pose estimation information by including the derived roll angle, pitch angle, and yaw angle of the vehicle. As described above, the second pose estimation information may include the Euler angle of the vehicle.

The controller 150 generates final pose estimation information about the vehicle using at least one of the first pose estimation information generated by the first estimator 130 and the second pose estimation information generated by the second estimator 140. The final pose estimation information may include the Euler angle of the vehicle.

The controller 150 may receive a failure signal for either the first inertial sensor 110 or the second inertial sensor 120 from the outside of the vehicle pose estimation device 100 (e.g. another or central electronic control unit (ECU) or micro controller unit (MCU)). The failure signal may indicate abnormality of a sensor. Depending on the content of the received failure signal, the controller 150 may generate the final pose estimation information as follows.

First, when the controller 150 receives a failure signal for the first inertial sensor 110 from the outside of the vehicle pose estimation device 100 and does not receive a failure signal for the second inertial sensor 120, the controller 150 may generate the final pose estimation information using the second pose estimation information, not the first pose estimation information. For instance, the controller 150 may use the second pose estimation information as the final pose estimation information.

In an embodiment of the present disclosure, the first pose estimation information generated by the first estimator 130 is relatively more influenced by the acceleration of the vehicle input to the estimation model of the Kalman filter. Therefore, when the first inertial sensor 110 is in an abnormal state (for example, the first inertial sensor 110 is broken, is not appropriately working, or is in a faulty or failure state), the accuracy of the first pose estimation information is lower than the accuracy of the second pose estimation information.

FIG. 2 is a graph showing first pose estimation information and second pose estimation information, which are obtained as results of performing a simulation for a situation in which a first inertial sensor is in an abnormal state and a second inertial sensor is operating normally, and actual vehicle pose information according to an embodiment of the present disclosure.

Referring to FIG. 2, when the first inertial sensor 110 is in the abnormal state and the second inertial sensor 120 is operating normally, the actual vehicle pose information cannot be precisely estimated from the first pose estimation information generated by the first estimator 130, whereas the actual vehicle pose information can be estimated from the second pose estimation information generated by the second estimator 140.

Therefore, when the controller 150 receives the failure signal for the first inertial sensor 110 and does not receive the failure signal for the second inertial sensor 120, the controller 150 may generate the final pose estimation information using the second pose estimation information only, not the first pose estimation information. For example, the controller 150 may use the second pose estimation information as the final pose estimation information. In other words, the controller 150 may select the second pose estimation information generated by the second estimator 140 as the final pose estimation information among the first and second pose estimation information.

Next, when the controller 150 receives the failure signal for the second inertial sensor 120 from the outside of the vehicle pose estimation device 100 and does not receive the failure signal for the first inertial sensor 110, the controller 150 may generate the final pose estimation information using the first pose estimation information only, not the second pose estimation information. For example, the controller 150 may use the first pose estimation information as the final pose estimation information.

In an embodiment of the present disclosure, the second pose estimation information generated by the second estimator 140 is relatively more influenced by the angular velocity of the vehicle used to correct the dynamic model of the sliding mode observer. Therefore, when the second inertial sensor 120 is in the abnormal state, the accuracy of the second pose estimation information is lower than the accuracy of the first pose estimation information.

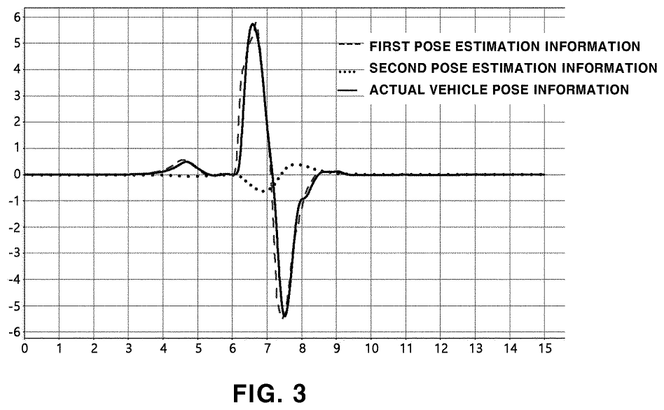

FIG. 3 is a graph showing first pose estimation information and second pose estimation information, which are obtained as results of performing a simulation for a situation in which a first inertial sensor is operating normally and a second inertial sensor is in an abnormal state, and actual vehicle pose information according to an embodiment of the present disclosure.

Referring to FIG. 3, when the first inertial sensor 110 is operating normally and the second inertial sensor 120 is in the abnormal state, the actual vehicle pose information can be estimated from the first pose estimation information generated by the first estimator 130, whereas the actual vehicle pose information cannot be precisely estimated from the second pose estimation information generated by the second estimator 140.

Accordingly, when the controller 150 receives the failure signal for the second inertial sensor 120 and does not receive the failure signal for the first inertial sensor 110, the controller 150 may generate the final pose estimation information using the first pose estimation information only, not the second pose estimation information. For example, the controller 150 may use the first pose estimation information as the final pose estimation information. In other words, the controller 150 may select the first pose estimation information generated by the first estimator 130 as the final pose estimation information among the first and second pose estimation information.

Further, instead of or in addition to determination of the abnormality using a signal received from the outside of the vehicle pose estimation device 100, the controller 150 may determine a failure situation when the first pose estimation information and the second pose estimation information differ by a predetermined standard or more. The controller 150 may determine the failure situation depending on whether the first pose estimation information and the second pose estimation information differ by the predetermined standard or more instead of or in addition to determination of whether the failure signal for either the first inertial sensor 110 or the second inertial sensor 120 is received from the outside of the vehicle pose estimation device 100.

When the first pose estimation information and the second pose estimation information differ by the predetermined standard or more, the controller 150 considers that abnormality such as a failure has occurred in either the first inertial sensor 110 or the second inertial sensor 120. When the abnormality such as the failure has occurred, the first inertial sensor 110 or the second inertial sensor 120 may output an inaccurate signal value unrelated to an actual state of the vehicle. In this case, it is difficult for the controller 150 to accurately determine which of the first inertial sensor 110 and the second inertial sensor 120 has a failure.

In consideration of this issue, according to an exemplary embodiment of the present disclosure, when the abnormality situation is detected or determined, the controller 150 may generate the final pose estimation information by mixing the first pose estimation information and the second pose estimation information, for example, but not limited to, averaging the first pose estimation information and the second pose estimation information. The controller 150 may maintain accuracy above a certain level by blending and using two pieces of information in a situation in which it is unclear from which of the first pose estimation information and the second pose estimation information the actual state of the vehicle is estimated.

In an embodiment of the present disclosure, when the abnormal situation is detected or determined, the controller 150 may generate an average value of the first pose estimation information and the second pose estimation information as the final pose estimation information.

Meanwhile, the first estimator 130, the second estimator 140, and the controller 150 may be integrally implemented in the form of, for instance, but not limited to, an electronic control unit (ECU) or micro controller unit (MCU). The first estimator 130, the second estimator 140, and the controller 150 may correspond to logical components according to operations performed thereby, and these components may be substantially implemented by a memory and one or more processors.

In this case, the memory may include at least one of a semiconductor device-based storage medium such as a random access memory (RAM), a read-only memory (ROM), or a flash memory, a magnetic medium such as a hard disk, a floppy disk, or a magnetic tape, an optical medium such as a compact disk read only memory (CD-ROM) or a digital video disk (DVD), and a magneto-optical medium such as a floptical disk.

Further, the processor may be a hardware unit that is capable of performing calculations and control within a computer. For example, the processor may include at least one arithmetic logic unit (ALU) and a processing register.

The vehicle pose estimation device 100 according to some embodiments of the present disclosure has been described in detail. Hereinafter, a vehicle pose estimation method according to an embodiment of the present disclosure will be described.

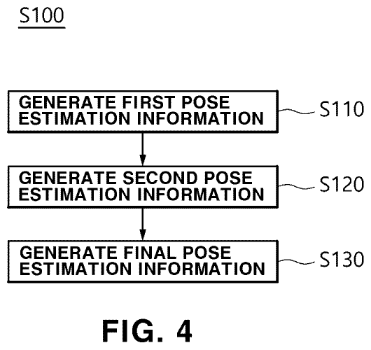

FIG. 4 is a flowchart of a vehicle pose estimation method according to an embodiment of the present disclosure.

A vehicle pose estimation method S100 according to an embodiment of the present disclosure estimates a pose of a vehicle. Here, pose estimation information of the vehicle may include, for instance, but not limited to, at least one of a roll angle, a pitch angle, and a yaw angle of the vehicle. Further, the pose estimation information of the vehicle may include an Euler angle that indicates a direction in which the vehicle is placed in a 3D space. However, the pose estimation information can be any information representing the estimated pose (e.g. a position or orientation) of a vehicle, for instance, but not limited to, an angle of the vehicle.

The vehicle pose estimation method S100 according to an embodiment of the present disclosure may be performed by the vehicle pose estimation device 100 described above.

Referring to FIG. 4, the vehicle pose estimation method S100 according to an embodiment of the present disclosure may be performed as follows.

First, the first estimator 130 generates first pose estimation information about the vehicle using acceleration measured by the first inertial sensor 110 and an estimated model variable obtained from an angular velocity measured by the second inertial sensor 120 (operation S110).

In this case, the acceleration may include 3-axis accelerations such as an x-axis acceleration, a y-axis acceleration, and a z-axis acceleration, and the angular velocity may include 3-axis angular velocities such as an x-axis acceleration, a y-axis acceleration, and a z-axis acceleration. The first pose estimation information may include, for example, but not limited to, at least one of the roll angle, the pitch angle, and the yaw angle of the vehicle. Further, the first pose estimation information may include an Euler angle of the vehicle.

In an embodiment of the present disclosure, the first estimator 130 may generate the first pose estimation information using a Kalman filter. In this regard, the 3-axis accelerations may be converted into a quaternion and input into the first estimator 130.

The generation of the first pose estimation information using the Kalman filter is the same or similar as described in association with the vehicle pose estimation device 100 according to an embodiment of the present disclosure. Therefore, detailed description thereof will be omitted.

Next, the second estimator 140 receives the acceleration and the angular velocity of the vehicle and generates second pose estimation information about the vehicle using the acceleration and the angular velocity of the vehicle (operation S120).

In this case, the second pose estimation information may include, for example, but not limited to, at least one of the roll angle, the pitch angle, and the yaw angle of the vehicle. Further, the second pose estimation information may include the Euler angle of the vehicle.

In an embodiment of the present disclosure, the second estimator 140 may generate the second pose estimation information using a sliding mode observer. In this regard, the second estimator 140 may utilize one or more dynamic models.

The generation of the second pose estimation information using the sliding mode observer is the same or similar as described in association with the vehicle pose estimation device 100 according to an embodiment of the present disclosure. Therefore, detailed description thereof will be omitted.

Meanwhile, the operation S110 of generating the first pose estimation information and the operation S120 of generating the second pose estimation information may be performed simultaneously. Alternatively, the operation S120 of generating the second pose estimation information may be performed first, and then the operation S110 of generating the first pose estimation information may be performed later.

Finally, the controller 150 generates final pose estimation information about the vehicle using at least one of the first pose estimation information and the second pose estimation information (operation S130).

Examples of the operation S130 of generating the final pose estimation information about the vehicle are described as follows.

First, when the controller 150 receives a failure signal for the first inertial sensor 110 from the outside of the vehicle pose estimation device 100 (e.g. another or central electronic control unit (ECU) or micro controller unit (MCU)) and does not receive the failure signal for the second inertial sensor 120, the controller 150 may generate the final pose estimation information using the second pose estimation information only, not the first pose estimation information. For instance, the controller 150 may use the second pose estimation information as the final pose estimation information. The failure signal may indicate abnormality of a sensor.

As described above, the first pose estimation information generated by the first estimator 130 is relatively more influenced by the acceleration of the vehicle input to the estimation model of the Kalman filter. Therefore, when the first inertial sensor 110 is in an abnormal state (for example, the first inertial sensor 110 is broken, is not appropriately working, or is in a faulty or failure state), the accuracy of the first pose estimation information is lower than the accuracy of the second pose estimation information.

Accordingly, when the controller 150 receives the failure signal for the first inertial sensor 110 and does not receive the failure signal for the second inertial sensor 120, the controller 150 may generate the final pose estimation information using the second pose estimation information only, not the first pose estimation information. For example, the controller 150 may use the second pose estimation information as the final pose estimation information.

Further, when the controller 150 receives the failure signal for the second inertial sensor 120 and does not receive the failure signal for the first inertial sensor 110, the controller 150 may generate the final pose estimation information using the first pose estimation information only, not the second pose estimation information. For example, the controller 150 may use the first pose estimation information as the final pose estimation information.

As described above, the second pose estimation information generated by the second estimator 140 is relatively more influenced by the angular velocity of the vehicle used to correct the dynamic model of the sliding mode observer. Therefore, when the second inertial sensor 120 is in the abnormal state, the accuracy of the second pose estimation information is lower than the accuracy of the first pose estimation information.

Accordingly, when the controller 150 receives the failure signal for the second inertial sensor 120 and does not receive the failure signal for the first inertial sensor 110, the controller 150 may generate the final pose estimation information using the first pose estimation information only, not the second pose estimation information. For example, the controller 150 may use the first pose estimation information as the final pose estimation information.

Additionally or alternatively, when the first pose estimation information and the second pose estimation information differ by the predetermined standard or more, the controller 150 may generate the final pose estimation information by mixing the first pose estimation information and the second pose estimation information. For instance, when the controller 150 mixes the first pose estimation information and the second pose estimation information, the controller 150 may generate an average value of the first pose estimation information and the second pose estimation information as the final pose estimation information.

When the first pose estimation information and the second pose estimation information differ by the predetermined standard or more, it may be considered that abnormality such as a failure has occurred in either the first inertial sensor 110 or the second inertial sensor 120. In this case, it is difficult for the controller 150 to accurately determine which of the first inertial sensor 110 and the second inertial sensor 120 has abnormality such as a failure.

In consideration of this, when the first pose estimation information and the second pose estimation information differ by the predetermined standard or more, the controller 150 may generate the final pose estimation information by mixing the first pose estimation information and the second pose estimation information. For instance, when the first pose estimation information and the second pose estimation information differ by the predetermined standard or more, the controller 150 may generate an average value of the first pose estimation information and the second pose estimation information as the final pose estimation information.

Certain embodiments of the present disclosure provide a non-transitory computer-readable storage medium storing a program for performing the vehicle pose estimation method S100. Specifically, some embodiments of the present disclosure may provide a non-transitory computer-readable storage medium in which a program including at least one instruction for performing the vehicle pose estimation method S100 is stored.

In this case, the instruction may include not only machine code generated by a compiler but also high-level language code executable by a computer. Further, the non-transitory computer-readable storage medium may include a magnetic medium such as a hard disk, a floppy disk, or a magnetic tape, an optical medium such as a CD-ROM or a DVD, a magneto-optical a such as a floptical disk, or a hardware device configured to store and execute program instructions, such as a ROM, a RAM, a flash memory, etc.

According to the above configuration, in the device and method for vehicle pose estimation and the non-transitory computer-readable storage medium storing the program for performing the method according to an aspect of the present disclosure, the pose of the vehicle can be accurately estimated by maximizing the advantages and compensating for the disadvantages of different types of inertial sensors, through a redundant structure.

In the device and method for vehicle pose estimation and the non-transitory computer-readable storage medium storing a program for performing the method according to an aspect of the present disclosure, the pose of the vehicle can be accurately estimated even when some of a plurality of inertial sensors are broken, through a redundant structure and selection of an estimated value according to the failure situation.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A device for estimating a pose of a vehicle, the device comprising:
a first inertial sensor configured to measure acceleration of the vehicle;
a second inertial sensor configured to measure an angular velocity of the vehicle; and
one or more processors configured to:
generate first pose estimation information of the vehicle using the acceleration of the vehicle and an estimated model variable obtained from the angular velocity of the vehicle;
generate second pose estimation information of the vehicle using the acceleration and the angular velocity of the vehicle; and
generate final pose estimation information of the vehicle using at least one of the first pose estimation information and the second pose estimation information.

2. The device of claim 1, wherein each of the first pose estimation information, the second pose estimation information, and the final pose estimation information includes an Euler angle of the vehicle.

3. The device of claim 1, wherein the first inertial sensor is configured to measure 3-axis accelerations, and the second inertial sensor is configured to measure 3-axis angular velocities.

4. The device of claim 3, wherein the one or more processors are configured to generate the first pose estimation information using a Kalman filter.

5. The device of claim 1, wherein the one or more processors are configured to generate the second pose estimation information using a sliding mode observer.

6. The device of claim 1, wherein the one or more processors are configured to, in response to a signal for indicating abnormality of the first inertial sensor and non-receipt of a signal for indicating abnormality of the second inertial sensor, output the second pose estimation information as the final pose estimating information.

7. The device of claim 1, wherein the one or more processors are configured to, in response to a signal indicating abnormality of the second inertial sensor and non-receipt of a signal for indicating abnormality of the first inertial sensor, output the first pose estimation information as the final pose estimation information.

8. The device of claim 1, wherein the one or more processors are configured to determine an abnormal situation based on whether difference between the first pose estimation information and the second pose estimation information is out of a predetermined standard.

9. The device of claim 8, wherein the one or more processors are configured to, in response to determination of the abnormal situation, mix the first pose estimation information and the second pose estimation information to generate the final pose estimation information.

10. The device of claim 8, wherein the one or more processors are configured to, in response to determination of the abnormal situation, average the first pose estimation information and the second pose estimation to generate the final pose estimation information.

11. A method of estimating a pose of a vehicle, the method comprising:
generating first pose estimation information of the vehicle using acceleration of the vehicle measured by a first inertial sensor and an estimated model variable obtained from an angular velocity of the vehicle measured by a second inertial sensor;
generating second pose estimation information of the vehicle using the acceleration and the angular velocity of the vehicle; and
generating final pose estimation information of the vehicle using at least one of the first pose estimation information and the second pose estimation information.

12. The method of claim 11, wherein each of the first pose estimation information, the second pose estimation information, and the final pose estimation information includes an Euler angle of the vehicle.

13. The method of claim 11, wherein the acceleration includes 3-axis accelerations, and the angular velocity includes 3-axis angular velocities.

14. The method of claim 11, wherein the first pose estimation information is generated using a Kalman filter.

15. The method of claim 11, wherein the second pose estimation information is generated using a sliding mode observer.

16. The method of claim 11, wherein the generating of the final pose estimation information comprises, in response to a signal for indicating abnormality of the first inertial sensor and non-receipt of a signal for indicating abnormality of the second inertial sensor, outputting the second pose estimation information as the final pose estimation information.

17. The method of claim 11, wherein the generating of the final pose estimation information comprises, in response to a signal for indicating abnormality of the second inertial sensor and non-receipt of a signal for indicating abnormality of the first inertial sensor, outputting the first pose estimation information as the final pose estimation information.

18. The method of claim 11, wherein, the generating of the final pose estimation information comprises, when difference between the first pose estimation information and the second pose estimation information is out of a predetermined standard, mixing the first pose estimation information and the second pose estimation information to generate the final pose estimation information.

19. The method of claim 18, wherein the mixing of the first pose estimation information and the second pose estimation information comprises averaging the first pose estimation information and the second pose estimation information to generate the final pose estimation information.

20. A non-transitory computer-readable storage medium configured to store instructions that when executed by one or more processors, cause the one or more processors to perform operations comprising:
generating first pose estimation information of a vehicle using acceleration of the vehicle measured by a first inertial sensor and an estimated model variable obtained from an angular velocity of the vehicle measured by a second inertial sensor;
generating second pose estimation information of the vehicle using the acceleration and the angular velocity of the vehicle; and
generating final pose estimation information of the vehicle using at least one of the first pose estimation information and the second pose estimation information.
